(19) United States
(12) Patent Application Publication
(10) Pub. No.: US 2005/0268703 A1
(43) Pub. Date: Dec. 8, 2005

(54) Sample receptacle for ultrasonic measurements

(76) Inventors: Theodor Funck, Gottingen (DE); Daniel Gau, Hofheim (DE)

Correspondence Address: DUANE MORRIS, LLP;IP DEPARTMENT, 30 SOUTH 17TH STREET, PHILADELPHIA, PA, 19103-4196, US

(21) Appl. No.: 11/092,245

(22) Filed: Mar. 29, 2005

Related U.S. Application Data
(60) Provisional application No. 60/557,882, filed on Mar. 31, 2004.

(51) Int. Cl. G01N 29/02

(52) U.S. Cl. 73/64.53

(57) ABSTRACT

A sample container (10) for ultrasonic measurements is described, having a container part (20), which forms a sample receptacle, the container part (20) having a wall material (21) whose composition and/or thickness is selected in such a way that ultrasound waves may be coupled with maximum transmission from the outside through the wall material (21) to the inside into the sample container (10). Methods for ultrasonic measurement of a sample in a sample container of this type, methods for manufacturing the sample container, and a construction comprising the sample container and a resonator chamber are described.

The present invention relates to sample containers for ultrasonic measurements having the features according to the preamble of claim 1, methods for ultrasonic measurement on free-flowing samples having the features of the preamble of claim 16, and methods for manufacturing the sample containers cited.

Detecting material properties of free-flowing samples through high-resolution measurements of the ultrasound velocity and/or the ultrasound absorption in the sample is known. The measurement is typically performed in a resonator chamber for receiving the sample. Exciting the walls of the resonator chamber to ultrasonic oscillations using externally attached ultrasonic transducers is suggested in U.S. Pat. No. 5,983,723. However, this technique may have disadvantages because of the complicated construction of the resonator chamber and the adjustment of the ultrasonic transducers. For interference-free measurement of the sample only positioned in the resonator chamber, it has additionally been shown to be advantageous if the sample has direct contact with the surface of the ultrasonic transducer, which is typically made of a metal. Thus, for example, ultrasonic transducers in resonator chambers according to DE 101 37 679 are located on inner walls of the resonator chamber and in direct contact with the sample.

However, ultrasonic measurement using direct transducer contact with the sample has an array of disadvantages. In many cases, interaction of the sample with a metal surface of the ultrasonic transducer cannot be excluded. For example, substances from the sample may adsorb on the transducer surface or the sample may have a corrosive influence on the transducer surface. In both cases, the transducer surface is altered, so that the measurement results may be corrupted. This is especially disadvantageous in the desired high-resolution measurement of the acoustic properties. A further problem is that adsorbed substances may frequently be removed from the metal surface of the transducer only with difficulty. This is particularly critical in measurements on biological samples, since undesired carryover of biological materials between different samples may not occur in the measurement.

For some substances, the high-resolution measurement of the ultrasound velocity in solid phase is significant. Also the tracking of phase transitions from solid to liquid or vice versa provides important conclusions about the physical properties of a substance through measurements of the ultrasound velocity. Up to this point, such measurements have only been possible through ultrasonic pulse measurement methods. The resolution of these methods is very limited at small sample dimensions, however.

A further disadvantage of the conventional ultrasonic measurements known from practice is that significant measurement errors may be caused if gas residues are also enclosed in the resonator chamber in addition to the sample. For example, as liquid samples are decanted, air may be included, particularly at the ultrasonic transducers. To avoid air inclusions, the sample may be decanted into the resonator chamber especially slowly and carefully. However, this is disadvantageous under practical conditions because it is time-consuming.

The object of the present invention is to provide an improved technique for ultrasonic measurements on fluid samples, using which the disadvantages of the typical resonator chambers may be overcome. In particular, undesired interactions of the sample with the transducer surface are to be avoided, pouring the sample into the resonator chamber without gas inclusions is to be made easier and accelerated, and contamination of the chamber by the sample is to be avoided.

This object is achieved by a sample container, a composite comprising a sample container and a resonator chamber, a method for ultrasonic measurement, and a method for manufacturing the sample container, having the features of claims 1, 14, 16, or 21, respectively. Advantageous embodiments and applications of the present invention result from the dependent claims.

In regard to the device, the present invention is based on the general technical teaching of providing a sample container for samples which is intended for being positioned with the sample in a resonator chamber and whose wall material is adapted in at least some regions, which are positioned adjoining the ultrasonic transducers when the sample container is inserted into the resonator chamber, for transmission of ultrasound with minimal loss. The inventors have determined that if a wall material is used which is optimized in regard to its composition and/or thickness for maximum transmission (e.g., greater than 99%), surprisingly, corruption of the measurement results is avoided, although the ultrasonic transducers and the sample are separated from one another by an additional foreign material (wall material). The provision of a sample container according to the present invention which is insertable into the resonator chamber advantageously provides the achievement of all of the above-mentioned objects. Thus, through the separation of sample and transducer surface, contamination or change of the transducer surface is prevented. Adhesion of harmful or dangerous substances to the transducer or substance transfer to subsequent samples is prevented. Restrictions in regard to the precision of the ultrasonic measurement are avoided. The sample container may be filled outside the resonator chamber. Multiple samples may be prepared in multiple sample containers, for example, while the measurements are performed in parallel in the resonator chamber. Time losses due to pouring samples into the chamber without bubbles are avoided.

A special advantage is achieving the above-mentioned objects when measuring solid samples or samples which contain solid-liquid phase transitions.

The enclosure of a solid which is smaller than the dimensions of the ultrasonic resonator measurement cell is enclosed in a sample container allows coupling to the transducers of the resonator measurement cell even with solid samples. In this case, this solid may be located inside the sample container in a coupling medium which differs from the coupling substance outside the sample container. In this way, phase transitions may be investigated even with the participation of liquid phases. By adjusting the different coupling media, it is possible to optimize the impedance conditions while reducing the reflection losses and thus improving the coupling of the sonic field into the sample. The sample container according to the present invention is therefore suitable both for fluid, free-flowing samples as well as for samples which contain a fluid and a solid component.

If, according to a preferred embodiment of the present invention, a container part of the sample container according to the present invention is made entirely from the wall material having maximum acoustic transmissivity, advantages may result for handling the sample container as it is inserted into a resonator chamber. If, according to a preferred variation, the container part forms a flexible bag, adaptation of the wall material to the inner wall of the resonator chamber and, in particular, to the ultrasonic transducers in the resonator chamber may be simplified.

According to a further preferred embodiment of the present invention, the sample container is provided with a holding device, to which the container part made of the preferably flexible wall material is attached. The holding device may have advantages for handling the sample container, for example, during transport from a filling device into the resonator chamber, and may assume additional functions. The holding device may be molded in one piece with the container part. However, providing the holding device as a separate component is preferred. If the holding device comprises a stopper, for example, which projects into the container part of the sample container, a closure of the sample container is also formed by the holding device.

If the stopper is equipped with a through opening, according to a further modification of the present invention, charging the sample container with a liquid sample may advantageously be simplified.

According to a further embodiment of the present invention, the holding device may be equipped with a closure element which fits in a form-fitting way in the through opening of the stopper and may be inserted or screwed therein. Using the closure element, if a sample container is completely filled, an excess pressure may advantageously be exerted on the sample in the sample container by advancing the closure element, under the effect of which the container part spreads out and unfolds completely. The closure part is a screw, for example, which works together with a fitted internal thread in the through opening.

Further advantages for flexible use and rapid assembly of the sample container may result if the container part is removably attached to the holding device. Particular advantages result if a retaining ring is used, using which the container part is attached to the stopper.

For the desired ultrasonic transmission, the wall material of the container part of a sample container according to the present invention preferably has a predetermined acoustic impedance, which is selected as a function of the acoustic impedance of the sample to be measured. Since the sample container has a simple construction and the container part may be manufactured cost-effectively as a disposable article, appropriately tailored container parts or sample containers may be prepared for measurements on different samples. It is especially advantageous for numerous practical applications if the acoustic impedance of the transducer material is equal to the acoustic impedance of the sample and the impedance of the coupling substance (e.g., 1.5×10⁶ kg m⁻²s⁻¹). The acoustic impedance is preferably selected in the range from approximately 1.0 to 2.0×10⁶ kg m⁻²s⁻¹.

According to a modified embodiment of the present invention, it is not absolutely necessary to select the wall material in regard to a specific acoustic impedance. It is possible, alternatively or additionally to the impedance adaptation, to select the thickness of the wall material in such a way that a minimum reflection and a maximum transmission is implemented by the wall material. It is known from the monograph of L. Bergman (“Der Ultraschall”, S. Hürzel Verlag, Stuttgart, 1954, page 15 et seq.), that the transmissivity of the wall material is a function of the wall thickness and the velocity of sound in the wall. Maxima of the transmissivity may occur at multiple wall thicknesses as a function of the operating conditions, so that the wall thickness may advantageously be selected in accordance with acoustic and constructive aspects.

For practical applications, a wall thickness in the range from 10 μm to 1 mm, particularly less than 100 μm, e.g. 10 μm up to 20 μm, is provided. According to an advantageous variation of the present invention, the wall thickness may particularly be less than or equal to 1/10 of the wavelength which is used for the ultrasonic measurement. The inventors have determined that even using low wall thicknesses, sample containers may be produced which are surprisingly sufficiently stable for use under practical conditions, particularly during filling, any possible transport, and/or measurement.

The wall material preferably comprises a polymer foil, such as one based on acetate, polypropylene, or polyethylene. The polymer foils used preferably have optical transparency, so that observation of the sample during filling is possible.

According to a further, especially advantageous embodiment of the present invention, a coupling substance is provided on the outside of the container part. This improves the acoustic coupling of the sample container on the surface of the ultrasonic transducers. The coupling substance may comprise water or an ultrasound contact gel known per se, for example.

In regard to the device, the above-mentioned object is also achieved by providing a combination comprising a sample container having the features described here and a resonator chamber known per se. The sample container may be permanently attached to the resonator chamber or, for example, removably fixed on its upper edge to ensure the desired protection of the ultrasonic transducers from the sample for an entire series of measurements, for example.

In regard to the method, the above-mentioned object is achieved by providing a method for ultrasonic measurement, in which the sample to be measured is filled into the sample container having the features described here and subjected to an ultrasonic measurement known per se in a resonator chamber, in which the sample is separated from the ultrasonic transducers, particularly by the wall material having the maximum transmission. According to a first variation of the method according to the present invention, the sample container may be charged with the sample when the sample container is not yet positioned in the resonator chamber. In this case, advantages may result in regard to avoiding gas influences in the sample container. Alternatively, the sample container may only be charged when it is positioned in the resonator chamber. In this case, lower requirements may be set on the stability of the wall material of the container part.

Preferred embodiments of the method according to the present invention are directed to the measurement of fluid, free-flowing samples or to samples which contain a fluid, free-flowing component and a solid component.

A further independent subject of the invention described here is a manufacturing method for manufacturing the sample container having the properties described here from a polymer foil. According to a first embodiment of the manufacturing method according to the present invention, an immersion method is provided, in which a temperature-controlled die is immersed in a polymer solution, so that a polymer layer forms on the die surface, which is subsequently subjected to drying. The temperature of the die is set according to the present invention to a predefined drying temperature, at which the wall material is in the free-flowing state. Preferably, a body having an external shape which corresponds to the desired internal shape of the container part and a polished surface, made of stainless steel, for example, is preferably used as a die, which may have its temperature controlled internally by an electrical heater or externally, e.g., through hot air. According to an altered embodiment of the manufacturing method, an extrusion or drawing method is provided, in which a foil made of the desired wall material is spread out on a hole matrix. A die is guided through the hole of the hole matrix, on whose surface the foil is positioned in accordance with the shape of the container part. The desired drying temperature of the die is also set in this case.

Further details and advantages of the present invention will become apparent from the following description of the attached drawings.

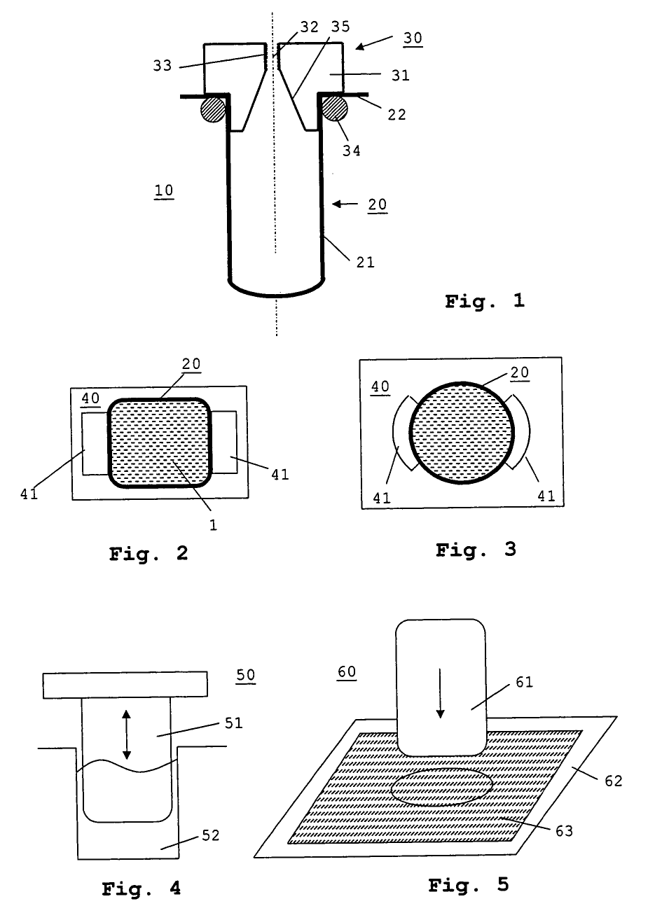

FIG. 1 shows a schematic sectional illustration of an embodiment of a sample container according to the present invention,

FIGS. 2, 3 show schematic sectional illustrations of sample containers according to the present invention in resonator chambers (without an illustration of the coupling substance), and

FIGS. 4, 5 show schematic sectional illustrations of devices for manufacturing sample containers according to the present invention.

The present invention will be described in the following with reference to preferred exemplary embodiments of sample containers according to the present invention having a round or essentially rectangular cross-section, which are equipped for resonator chambers-having two plane or curved ultrasonic transducers. It is emphasized that the implementation of the present invention is not restricted to these designs, but rather other geometric shapes and/or sizes may also generally be implemented.

The sample container 10, schematically illustrated in a sectional view, comprises a container part 20 and a holding device 30 as shown in FIG. 1. The container part 20, which is illustrated for reasons of clarity with a thick solid line, but comprises an extremely thin-walled wall material 21 in practice, comprises the wall material 21, produced in a bag shape, and a collar 22, formed integrally with the wall material.

The wall material comprises cellulose acetate foil, polyvinyl acetate, polypropylene, or polyethylene, for example. The thickness of the wall material 21 is selected in the range from 10 μm to 20 μm, for example. The volume of the container part 20 is 170 μl in the example shown.

The holding device 30 is a stopper made of a thermoplastic material (e.g., PVC). The bottom of the stopper 31 projects into the container part 20. The stopper 31 has a peripheral projection on its lower side, pointing toward the container part 20, to which the external diameter of the stopper 31 enlarges starting from a value corresponding to the internal diameter of the container part 20 to the desired external dimension of the top side of the holding device 30. The container part 20 is attached at the projection to the stopper 31 by a peripheral O-ring 34.

The stopper 31 has an axial hole 32, on whose upper part a thread 33 is provided and which expands toward the container part 20 in accordance with a conical surface 35.

A method according to the present invention for ultrasonic measurement on a sample using the illustrated sample container 10 comprises the following steps. The sample container is first filled with the liquid sample. For this purpose, the sample is decanted through the through opening 32 into the container part 20 using a pipette or a syringe, for example. The injection is performed up to a filling level, which is in the region of the thread 32. Subsequently, a screw (not shown) is screwed as a closure element into the thread 33. Under the effect of the pressure exerted on the liquid at the same time, the wall material 21 of the container part 20 is tightened. As this pressure is exerted, the tightness of the sample container 10 may be observed visually. If undesired pores or cracks arise, they are recognizable immediately by escaping liquid. The corresponding sample is discarded. After successful charging of the sample container, it is inserted into a resonator chamber. Since the external shape of the container part 21 is selected as essentially identical to the internal shape of the resonator chamber, the sample container 10 may simply be pushed into a resonator chamber.

For coupling between the ultrasonic transducers 41 of the resonator chamber 40 (see FIGS. 2, 3) and the sample container 20, a coupling substance is located in the resonator chamber. Alternatively, this substance is provided before the sample container 20 is inserted into the resonator chamber 40. The actual ultrasonic measurement then follows. Details of the ultrasonic measurement and the sonic parameters used are not described here, since these are known per se. For example, resonance frequencies are detected in the liquid-filled resonator chamber.

FIGS. 2 and 3 show a schematic sectional view of the composite comprising the sample container 20 having the sample 1 (shown dashed) and the resonator chamber 40 having the ultrasonic transducers 41. For example, flat ultrasonic transducers 41 (FIG. 2) or curved ultrasonic transducers 41 (FIG. 3) may be provided.

FIGS. 4 and 5 schematically illustrate an immersion device 50 and a drawing device 60 for manufacturing the container part 20 of the sample containers 10 according to the present invention. In the immersion device 50, a temperature-controlled die 51 is immersed once or multiple times in a liquid polymer solution 52 and finally withdrawn. The polymer layer remaining on the die surface is dried at the predefined drying temperature. The drying temperature is determined empirically as a function of the polymer material and the layer thickness formed (polymer concentration in the solution 52) for the specific material through test series.

In the drawing device 60 (FIG. 5), the temperature-controlled die 61 is pushed through a hole matrix on which the foil 63 of the polymer material is located to produce the container part 20.

After the shaping of the wall material 21 on the die 51 or 61, the wall material is stripped off the die 51 or 61 as the container part 20 and connected to the holding device 30 using the O-ring 34 (see FIG. 1).

The features of the present invention disclosed in the above description, the drawing, and the claims may be of significance both individually and in combination for the implementation of the present invention in its various embodiments.

1. A sample container for ultrasonic measurements, having a container part, which has a wall material and which forms a sample receptacle, wherein at least one of a composition and a thickness of the wall material is selected in such a way that ultrasound waves may be coupled from the outside through the wall material to the inside into the sample container with maximum transmission.

2. The sample container according to claim 1, wherein the container part completely consists of the wall material.

3. The sample container according to claim 1, wherein the wall material is flexible.

4. The sample container according to claim 3, wherein the wall material forms a flexible bag.

5. The sample container according to claim 3, wherein the wall material is dimensionally stable when the container part is in an emptied state.

6. The sample container according to claim 1, wherein the container part has a holding device.

7. The sample container according to claim 6, wherein the holding device has a stopper, which projects into the container part.

8. The sample container according to claim 7, wherein the stopper has a through opening.

9. The sample container according to claim 8, wherein the through opening has an internal thread.

10. The sample container according to claim 7 wherein the container part is removably attached to the stopper using a retaining ring.

11. The sample container according to claim 1, wherein the wall material the container part has an acoustic impedance which is selected to be identical to the acoustic impedance of a sample in the sample container.

12. The sample container according to claim 10, wherein the acoustic properties of the wall material of the container part are adapted to the properties of a coupling substance and to a content of the container.

13. The sample container according to claim 1, wherein the wall material of the container part has a thickness which is less than or equal to 1/10 of the wavelength of the ultrasound waves.

14. The sample container according to claim 12, wherein the thickness of the wall material is selected in the range from 1 μm to 1 mm.

15. The sample container according to claim 1 wherein the wall material consists of a polymer foil.

16. A resonator chamber for ultrasonic measurements, in which a sample container according to claim 1 is positioned.

17. The resonator chamber according to claim 16, wherein a coupling substance is positioned between the container part of the sample container and the inner wall of the resonator chamber.

18. A method for ultrasonic measurement on a sample, comprising the steps of:
filling the sample into a sample container according to claim 1, and
ultrasonic measurement of the sample in a resonator chamber, the sample being separated from surfaces of ultrasonic transducers by the wall of the sample container and a coupling substance.

19. The method according to claim 18, wherein the sample container with the sample decanted therein is inserted into the resonator chamber.

20. The method according to claim 19, wherein the sample is filled into the sample container inserted into the resonator chamber.

21. The method according to claim 18 wherein a fluid, free-flowing sample is filled into the sample container.

22. The method according to claim 18, wherein a sample, which is composed of at least one fluid, free-flowing component and at least one solid component, is filled into the sample container.

23. A method for manufacturing a sample container according to claim 1, wherein the container part is shaped on a die through immersion or drawing, the die being temperature-controlled to a predefined drying temperature.
